(19) United States
(12) Patent Application Publication
(10) Pub. No.: US 2012/0144311 A1
(43) Pub. Date: Jun. 7, 2012

(54) COMPUTERIZED SYSTEM AND METHOD FOR COMMENTING ON SUB-EVENTS WITHIN A MAIN EVENT

(75) Inventors: Kenneth Yeh, El Monte, CA (US); Gladys Kong, Pasadena, CA (US)

(73) Assignee: Chime.in Media Inc., Pasadena, CA (US)

(21) Appl. No.: 13/030,995

(22) Filed: Feb. 18, 2011

Related U.S. Application Data
(60) Provisional application No. 61/420,724, filed on Dec. 7, 2010.

(51) Int. Cl. G06F 3/048

(52) U.S. Cl. 715/744

(57) ABSTRACT

A news commenting server includes a filtering unit for allowing only trusted or curated users/authors to post comments in a particular portion of a web page of a news website. The news commenting server may also include a comment receiver for receiving comments and associating the comments with a selected one (and not all) of several sub-events that describe a main event. A formatting unit may present the user comments and the associated sub-event in on the same frame, in the web page of the news website. Other embodiments are also described and claimed.

This non-provisional application claims the benefit of the earlier priority date of U.S. provisional application No. 61/420,724 filed Dec. 7, 2010.

### BACKGROUND

News and reporting websites (“news websites”) provide detailed information on events to users or followers (“users”) as the events transpire. This information is typically stored on a server in a web compatible format. For example, information may be formatted or presented using HyperText Markup Language (HTML), Java Script, Extensible Markup Language (XML), etc. Following a request from an external computer, this information may be transmitted by the server over the Internet to the external computer where it is presented to the user through a client program of a web interface, such as Microsoft Internet Explorer, Apple Safari, Mozilla Firefox, etc.

Users go to news websites to view news events and related information. Additionally, users can submit text comments through commenting systems provided by the news websites. In some cases these commenting systems are proprietary and are created specifically for each news website. In these systems, users are required to create an account and will then need to login to the proprietary commenting system prior to commenting on the event. In other cases, news websites may incorporate third party commenting systems, such as Facebook Connect and Twitter. These third party commenting systems allow users to login to their existing Facebook or Twitter accounts instead of requiring the creation of an additional account for each news website a user wishes to comment on.

After logging into either the third party or proprietary commenting system of a news website, a user may comment on an event presented on the website. The comments are thus inherently associated with the event, and are displayed to other users who are also viewing the event on the news website.

Over time, numerous users may post comments on a given event. These comments are typically listed chronologically and contained in a single frame or pane of the news website.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a screen shot of a web interface showing play-by-play sub-events and user comments according to an embodiment of the invention.

FIG. 2 is a screen shot showing a login modal window and a sub-event window containing buttons for predetermined comments by a sports news website according to an embodiment of the invention.

FIG. 3 shows a modal window for allowing a user to enter comments according to an embodiment of the invention.

FIG. 4 is a block diagram of news website commenting server according to one embodiment of the invention.

FIG. 5 is a flow diagram of a method for making comments on a news website according to one embodiment of the invention.

### DETAILED DESCRIPTION

An embodiment of the invention is directed to a computerized method and system that allows users of a news website to comment on sub-events within a main event. A main event is an organized commercial (i.e. paid for or commercially sponsored) contest in which several persons compete for a set prize or outcome. The main event has a pre-defined beginning and end, e.g. a start time and a stop time or a predetermined time interval (such as four fixed quarters in a football or basketball match), a start time and, instead of a definite stop time, a maximum number of contest goals (such as three sets in a tennis match, nine innings in a baseball match, and a fixed number of laps in an automobile circuit race). The outcome or prize is not awarded until the end has been reached. Also, the main event in most cases takes place in a predefined, and restricted physical location such as a stadium or building. However, “location” may alternatively be geographically distributed over several cities, e.g. a stage in a professional bicycle race or an automobile rally. In contrast to the main event, a sub-event is actually a data structure that describes an activity or incident that has taken place in a main event. The sub-event is received by a computer system in “real-time”, as a snapshot of the on-going main event, and encompasses a relatively brief time interval or action sequence within the much larger main event. In most instances, sub-events describe a noteworthy action that has been preformed by or upon a contestant in the contest. For purposes of conciseness and clarity, a sports news website reporting on a sports contest will be used as an example to describe the elements of the invention if no other news website is designated. However, the elements described here equally apply to other news websites, such as an entertainment news website (e.g. reporting on a motion picture awards ceremony, a singing competition, or a reality television game show), a technology news website (e.g. reporting on the launch of a new automobile), a politics news website (e.g. reporting on apolitical election), etc.

A sports news website is a type of news website that focuses on the presentation of information and news associated with sporting contests. For example, Sports Team Analysis and Tracking Systems, Inc. (STATS), Entertainment and Sports Programming Network (ESPN) and Sports Illustrated (SI) present play-by-play commentary on a variety of live sporting contests through the sports news websites www.stats.com, www.espn.com and www.si.com, respectively. Sports news websites present their play-by-play commentary to users through a web-based user interface. A user may access the website (including any web server or server network) through a web browser running on the user's client computer. In one embodiment, the user's computer is a desktop personal computer with a hardware processor, a network interface, and main memory in which an operating system and application programs (such as the web browser) are stored for execution by the processor. In other embodiments, the user's computer is a laptop, a personal digital assistant, a mobile phone, a television set-up box or other similar consumer electronic networked computing platform.

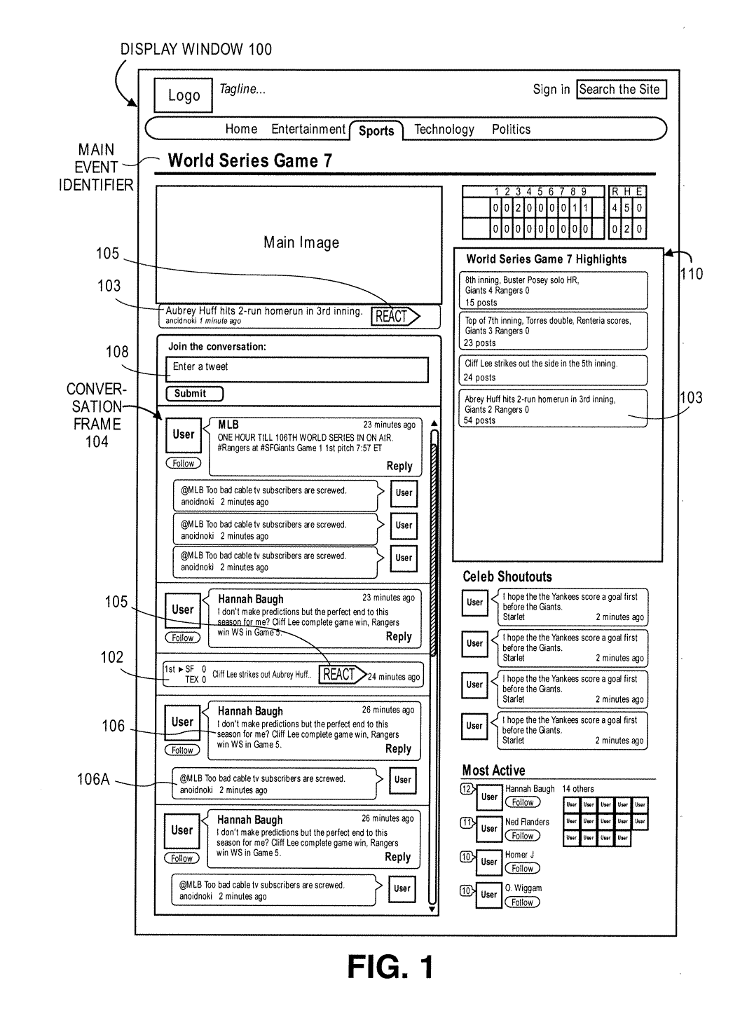

FIG. 1 shows a screen shot of a display window 100 (part of a web-based user interface) that may be displayed on the user's client computer during interaction with a news websites server. In this embodiment, the play-by-play commentary of the seventh game of a baseball championship series is presented to a user. In this example, game seven of the World Series is the main event while play-by-play sub-event window 102 (i.e. “Cliff Lee strikes out Aubrey Huff”) and sub-event window 103 (“Aubrey Huff hits 2-run homerun in 3^{rd} inning”) refer to distinct real-life incidents involving contestants that occur within the main event. The sub-event window may be in a different color than all other windows of the web user interface, which are being shown in the display window 100. To further illustrate the sub-event, the window 103 may also contain one or more images (e.g. a still picture or videoclip of the real-life incident) that may be “seeded” or inserted by an administrator or operator of the news website, or by a user of the website. As such, sub-events are not user comments; rather, they are factual descriptions (with essentially no opinion) of the respective activities or happenings that are taking place in the main event.

As shown in FIG. 1, conversation frame 104 displays play-by-play sub-events occurring in the baseball game along with commentary from users of the sports news website. In particular, play-by-play sub-event window 102 is provided by administrators of the sports news website and describes a play or incident that recently took place in the main event. In contrast, user comment window 106 contains an observation or comment made by a website user (“Hannah Baugh”) in response to activity taking place in the main event. The comment may have arrived at the website via a tweet or other suitable Internet-based comment mechanism. Each sub-event or comment is displayed in a single separate window box as shown, except for clustered comments (as explained below). As noted above, play-by-play sub-events may be manually entered into a server by an administrator of the sports news website, who is watching, listening, or otherwise perceiving the activity of the main event or game at the same time. These manually entered sub-events are then immediately presented to users who visit the website, in conversation frame 104 of the web interface, as real-time or live reports during the game. In another embodiment, one or more of the play-by-play sub-events may be automatically retrieved from a commercial sports information provider that electronically publishes sports statistics, play-by-play coverage, and/or other similar pieces of information. For example, a server associated with the sports news website may automatically retrieve play-by-play sub-events from a remote computer that publishes play-by-play sub-events for a baseball game. The sports news website's server may retrieve the play-by-play sub-events through either a pull, push, or other similar data retrieval scheme. The automatically retrieved play-by-play sub-events are then immediately presented to users through conversation frame 104 of the web interface (as real-time or live reports during the game).

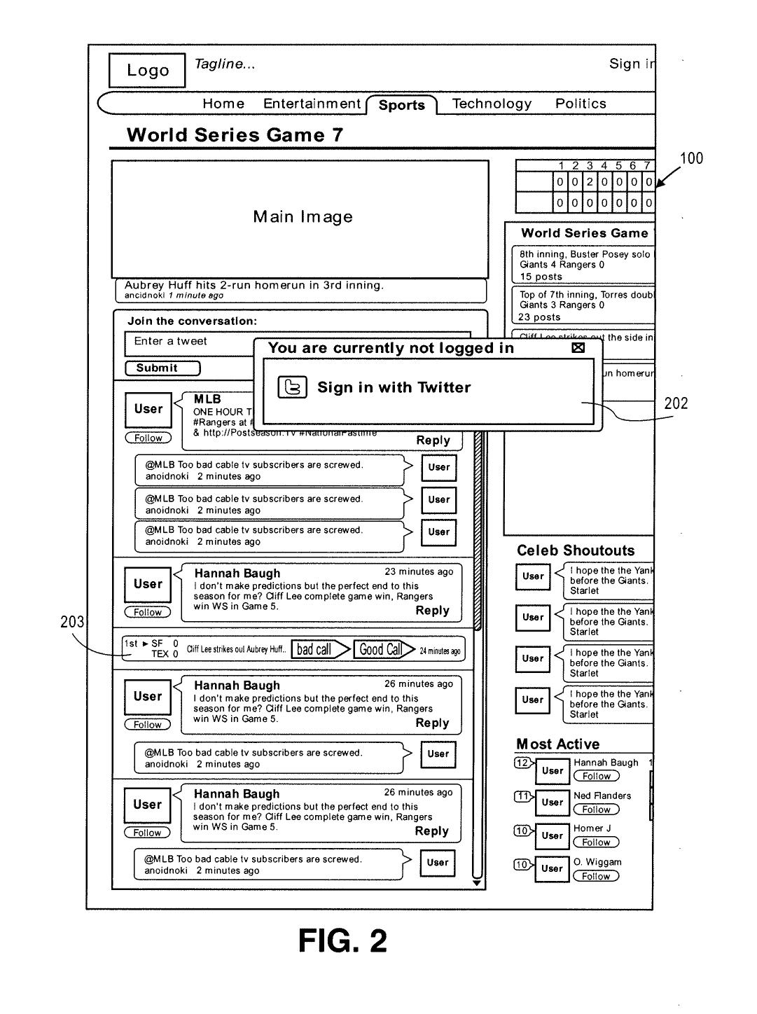

Having described the play-by-play sub-events that may be inputted by an administrator of a sports news website, the input of users of (or visitors to) the website will now be described. Such input is in the form of comments that may be entered by one or more users (who are signed into a commenting system provided by the sports news website). In one embodiment, the commenting system includes proprietary software that is created specifically for the sports news website. In this system, users may be required to create an account and login to the proprietary commenting system, prior to commenting on an event. In other cases, the sports news website incorporates one or more third party commenting systems, such as Facebook Connect and Twitter. These third party commenting systems allow users to login to their existing Facebook or Twitter accounts instead of requiring the creation of an additional account for the sports news website. As shown in FIG. 2, a modal window 202 in the sports news website prompts the user to login using Twitter account credentials.

### Deterministic Association of Comments

Referring back to FIG. 1, upon logging in, a user may use comment input box 108 to create a first level comment, that may then be displayed by the news website or server within a new user comment window 106. The user may enter text into comment input box 108 and then select the “submit” button to create a first level comment. The input box 108 may be persistent in that it remains on display throughout the entire main event, always available for the user to enter a new comment. Such a comment may be immediately associated with the main event identified in the display window 100, by virtue of having been entered through selection of the “submit” button in the input box 108, which has been previously associated in the server with the main event. This is referred to here as a deterministic association of the received comment. The first level comment is transmitted from the user's client computer to the sports news website's servers, and may then be essentially broadcast to the computer of every user who is following this main event through the sports news website, such that it may be shown in the display window 100 on each user's computer. In other words, no analysis of the received comment content or its author is required here. Note that the first level comment may be displayed in sequence relative to the arrival into the server of other first level comments and sub-events.

In one embodiment, the news website server adds a “React” button or link 105 into a sub-event window (e.g. windows 103, 102) as shown. This allows the user to enter a first level comment that is immediately associated with a corresponding sub-event, without the server having to perform any analysis upon the received comment (to make the association). An input box similar to box 108 may appear in the user interface, in response to the user clicking on the “React” button; the box may then disappear as soon as the text of the comment has been received by the news website server. Once associated with each other, the new user comment and the sub-event can be formatted by the server so as to be shown within the same frame of the web page containing the display window 100, adjacent to each other (as shown).

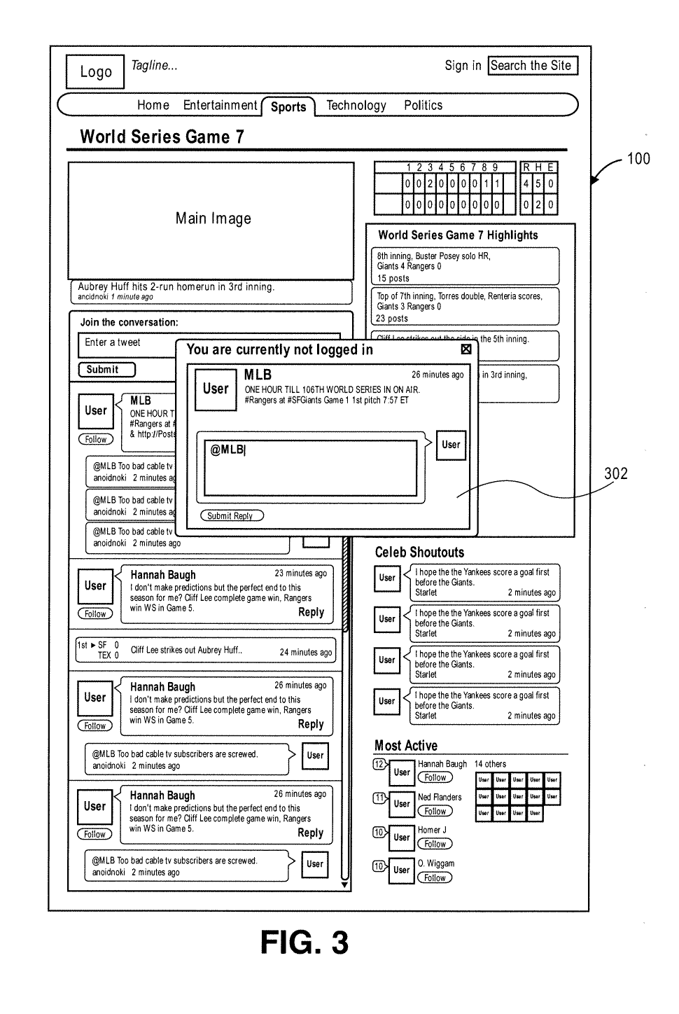

A user may create a second level comment, such as comment 106a, by replying to a first level comment. To reply to a first level comment, a user clicks or otherwise selects a “Reply” link that has been, in essence, previously associated with the first level comment, i.e. the link has been previously defined to be “with” the fist level comment and thus appears in the same first level comment window as shown. The user may then be prompted with a modal window 302 (see FIG. 3). The user may enter text into the modal window input box and submit the entered text as a reply to comment window 106 (see FIG. 1) by clicking or otherwise selecting the “Submit Reply” button. After text is submitted through the modal window 302, a second level comment is created that is associated with the main event, and in particular the comment window 106. The second level comment is thereafter transmitted to the sports news website's servers and then broadcast to the computer of every user following the main event through the sports news website such that it may shown in the web user interface displayed on each user's computer, in context with the first level comment.

In another embodiment, a user may post a comment by creating and transmitting to the server any of several available predetermined comments. Several predetermined comment buttons may be displayed by the server in context with a given play-by-play sub-event (e.g. in the same sub-event window 203 as shown in FIG. 2), that are associated with not just the main event but also the particular play-by-play sub-event. The predetermined comment that corresponds to the user-selected button is thereafter broadcast to the computer of every user following the main event through the sports news website, in the display window 100 on each user's computer. The predetermined comments may be represented by displaying icons or emoticons. For example, a thumbs up, thumbs down, smiley face, and sad face may be used to represent predetermined comments.

In some embodiments, the predetermined comments may be specific to the context of the play-by-play sub-event with which they are associated. For instance, for a play-by-play sub-event related to a judgment call made by a referee, umpire or other official (e.g. “Aubrey Huff takes ball three.”), the available predetermined comments may be “Good Call” and “Bad Call.” In another instance in which a player makes a questionable play (e.g. “Cliff Lee intentionally walks Aubrey Huff.”), the predetermined comments may be “Bad Play” and “Good Play.”

### Non-Deterministic Comment Association

In one embodiment, first level and second level comments are analyzed and associated with play-by-play sub-events automatically by the server, using a non-deterministic comment association algorithm. In this embodiment, a comment is not associated to a play-by-play sub-event by the mere selection of a link or button (that has been previously set by the server to be associated with the sub-event). Instead, the server determines through analysis a relationship between the comment and one of several play-by-play sub-events and then creates an association based on that determination. This relationship may be determined by comparing the contents of the comment with that of the play-by-play sub-events, the temporal relationship or timing between when the comment is received by the server and when the play-by-play sub-events have been displayed for the first time, and/or by comparing some other set of characteristics between the comment and the play-by-play sub-events.

### Highlight Frame

Highlight frame 110 of the web user interface (see FIG. 1), which contains highlights of a main event, will now be described. In one embodiment, highlight frame 110 shows a subset of all play-by-play sub-events that have been received for the main event. The subset of play-by-play sub-events represents sub-events that are of particular importance to the main event. For example, important sub-events may be actions that strongly affect the outcome of a game (e.g. game winning home run) or are otherwise notable (e.g. Cliff Lee throws his 1,000 strikeout).

The importance of play-by-play sub-events (and hence whether or not they are displayed in the highlight frame 110) may be determined manually by an administrator of the sports news website or it may be determined automatically using a computer implemented algorithm. In one embodiment, the importance of a play-by-play sub-event is determined based on the number of comments that have been posted explicitly for it by users. A play-by-play sub-event is considered important if it receives more than a predefined number of user comments. In one embodiment, the number of user comments considered for the importance determination may be a filtered version of all comments received for a sub-event, such that multiple comments left by the same user and that relate to or have been posted for the same sub-event are considered a single comment.

Although determining the importance of play-by-play sub-events has been described in terms of the number of user comments, other factors may be considered as well including, for example, the content of user comments, the number of exclamation points used in comments, the number of comments containing all capital letters, the number of words in comments, etc.

As shown in FIG. 1, highlighted play-by-play sub-events may be displayed in the highlight frame 110 along with a link to the user comments or posts that are associated with each play-by-play sub-event. When clicked, these links show all of the user comments that have been associated with the corresponding play-by-play sub-event.

### Curated Comment List

In one embodiment, the sports news website (its servers) may filter the received user comments based on various criteria, before broadcasting for display those comments that are only from curated or “trusted” authors. This may be applied to the first level comments that are being posted against a sub-event window (e.g. comment window 106 in context with sub-event window 102—see FIG. 1). In particular, the sports news website may filter comments based on the identities of their respective users (authors). In this embodiment, the sports news website could compare the login credentials of a user attempting to leave a comment against a list of trusted users. If the user attempting to leave a comment is located on the list of trusted users, the user is allowed to leave a comment while users not on the list of trusted users are not allowed to leave a comment. In one embodiment, all users are given the same web user interface (display window 100 will reflect the same window and comment submit buttons), and the filtering of comments is performed at the server after those comments have been received from the users' client machines. In another embodiment, users are allowed to leave comments, i.e. their comments may be displayed in the window 100, regardless of whether the user's credentials appear on the list of trusted users. However, in that case, the user's comment is placed in a fewer number of locations on the display window 100, if the user's credentials do not appear on the list of trusted users. For example, if the user's credentials appear on the list of trusted users, the user's comment appears in both conversation frame 104 and highlight frame 110 (assuming the sub-event associated with the user's comment is determined to be a highlight). In contrast, if the user's credentials do not appear on the list of trusted users, a comment left by this user appears in the conversation frame 104 but not in the highlight frame 110.

The list of trusted users may include credentials of users that are considered reputable with respect to the main event and will likely leave high quality comments, e.g. well known sports reporters or writers. The list may be manually generated by an administrator of the sports news website and/or it may be generated automatically based on feedback from other users. For example, the sports news website may determine that previous comments by a particular user were popular (e.g. a large number of second level comments were posted to a first level comment by that user). Based on this popularity, the sports news website determines that the user is reputable and will likely leave high quality comments. Accordingly, the user's credentials are added to the list of trusted users.

### Clustering

In another example embodiment, the sports news website may filter and/or cluster the received comments from general users, i.e. those that are not on the trusted list, based on the content of the comments. For instance, in reply to the play-by-play sub-event “Cliff Lee strikes out Aubrey Huff,” several users may reply with the comments “Good job,” “Nice work,” “Well done,” etc. The sports news website analyzes these user comments and notes that they effectively state the same idea (i. Cliff Lee performed well). Accordingly, the sports news website may cluster or combine these comments into a single unified comment that is attributed to all of the different authors. The unified comment may use the text from one of the original user comments or alternatively use an entirely different set of words that capture the same sentiment as the original set of user comments. The unified comment may be displayed in a single second level comment window 106a.

### Server System

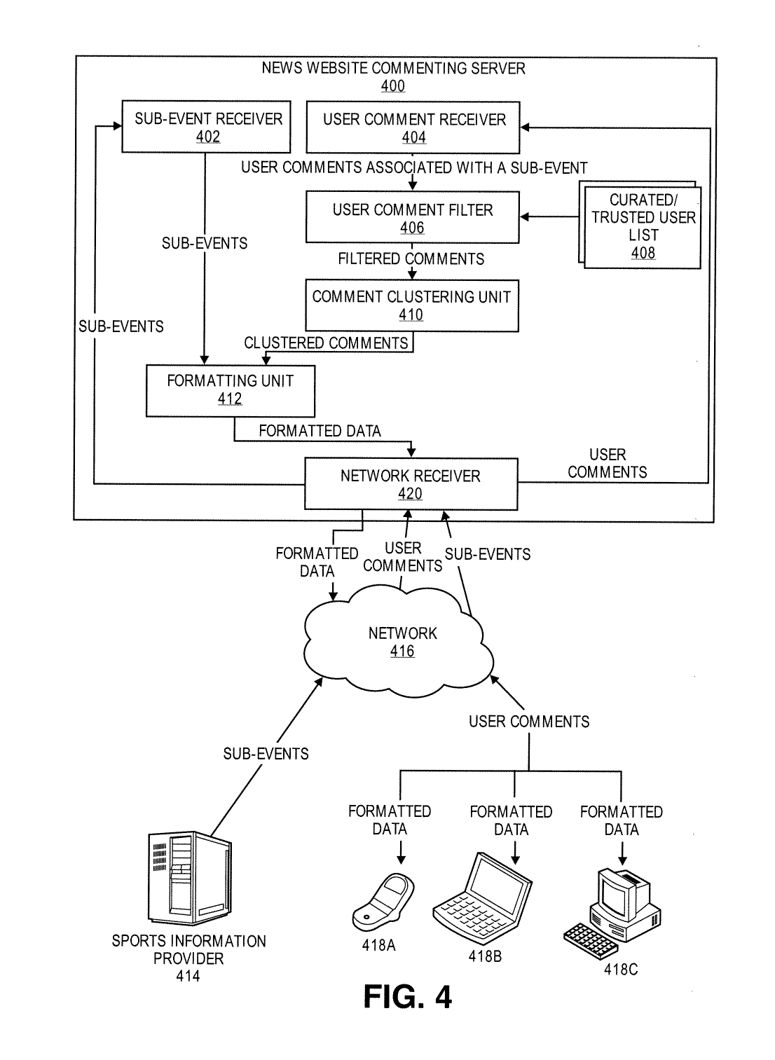

FIG. 4 shows a news website commenting server 400 that may be used to perform the commenting functions described above. In one embodiment, the news website commenting server 400 consists of a single computer that includes one or more hardware processors and associated main memory units containing the software needed for performing the various commenting functions. In other embodiments, the news website commenting server 400 may consist of several networked computers that jointly perform the comment processing functions. The news website commenting server 400 includes a sub-event receiver 402. The sub-event receiver 402 receives sub-events that occur during a main event. As described above, the sub-events may be received from an administrator of the news website who manually enters each sub-event into the commenting server 400 through a computer workstation connected to the news website commenting server 400. Alternatively, the sub-events may be received automatically from a sports information provider 414 that electronically publishes sports statistics, play-by-play coverage, and/or other similar pieces of information. The news website commenting server 400 may retrieve the play-by-play sub-events through either a pull, push, or other similar data retrieval scheme. The news website commenting server 400 includes a network interface 420 that allows it to communicate with a remote system (being that of the service provider 414) over the Internet (network 416) using the appropriate protocols. The sub-events may be passed to a formatting unit 412 after creation. The formatting unit 412 is described in greater detail below.

The news website commenting server 400 may also include a user comment receiver 404. The user comment receiver 404 receives comments from users. As shown in FIG. 4, users may enter comments through remote computing devices 418 connected to the news website commenting server 400 through a network 416 (e.g. the Internet). In one embodiment, the user comments are passed from the network 416 to the comment receiver 404 through the network interface 420. The computing devices 418 may be a laptop, a personal digital assistant, a mobile phone, or another similar consumer electronic computing platform.

In one embodiment, the comment receiver 404 associates user comments with sub-events. This association may be deterministic, i.e. based solely on a selection made by the author of a comment through the web interface (e.g. by clicking on a “react” or “reply” button that was previously associated with the sub-event by the news website, resulting in the received comment being associated with that sub-event and not any others), or it may be non-deterministic, i.e. automatically by the comment receiver 404 based on its analysis of the content of the user comment.

Upon receiving user comments, the comment receiver 404 transmits the user comments to user comment filter 406. User comment filter 406 may filter the received user comments based on various criteria. For example, the user comment filter 406 may filter user comments based on the identities of their respective users (authors). In this embodiment, the user comment filter 406 compares the login credentials of a user that entered a comment against a list of curated/trusted users 408 such that only trusted user comments are passed through one port of the filter, while those of general users or untrusted authors are passed out through another port of the filter. Based on filtering performed by the user comment filter 406, a set of filtered comments are sent to comment clustering unit 410.

Upon receiving the filtered comments, the comment clustering unit 410 may combine filtered comments that effectively state the same idea. Accordingly, the comment clustering unit 410 may cluster or combine similar comments from general users, into just one unified or clustered comment that is attributed to each of the users. Multiple users (authors) may thus be listed within a single comment window. The clustered comment may use the text from one of the original user comments or alternatively use an entirely different set of words that capture the same sentiment as the original set of user comments. The clustered comments may be passed to a formatting unit 412 after creation.

Upon receiving any sub-events and/or clustered comments, the formatting unit 412 may format the received data such that it can be transmitted and displayed on the remote computing devices 418 (in accordance with the web user interface). In one embodiment, the formatting unit 412 may cause a comment to be displayed in a window box that is adjacent to the window box of its associated sub-event.

The formatting unit may format the sub-events and/or clustered comments using Extensible Markup Language (XML), Comma-separated values (CSV), Structured Data eXchange Formats, Abstract Syntax Notation One (ASN.1), Property list, Hypertext Markup Language (HTML), or similar formats that may be used in a web page.

After formatting the sub-events and/or clustered comments, the formatted data is delivered to computing devices 418 through the network interface 420 prior to being delivered to the network 416 and ultimately to the computing devices 418 where it may be displayed in a window (as shown in FIG. 1). The news website commenting server 400 may make the formatted data available to the computing devices 418 through either a pull, push, or other similar data retrieval scheme.

### Process Flow

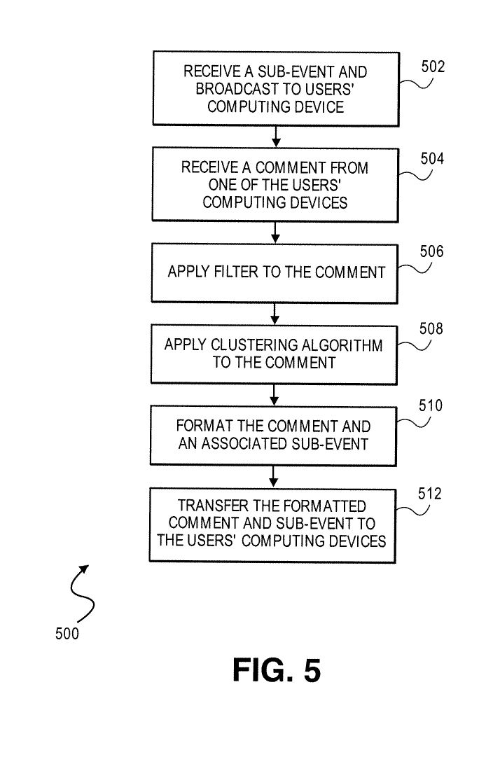

FIG. 5 shows a flow diagram of a news website commenting method 500 according to one embodiment of the invention. The method 500 of FIG. 5 may be implemented using the news website commenting server 400 shown in FIG. 4. Example associations between the physical components of the news website commenting server 400 and the operations or acts that make up the news website commenting method 500 will be provided for clarity and should not be read to limit the invention.

The news website commenting method 500 begins with the receipt of a sub-event of a main event at operation 502. As described above, the sub-events may be received from an administrator of a website who manually enters each sub-event into the commenting server 400 through, for example, a personal computer workstation connected to the news website commenting server 400. Alternatively, the sub-events may be received from remote sports information provider. In one embodiment, the operation of receiving a sub-event is performed by the sub-event receiver 402. In another embodiment, the operation of receiving a sub-event is performed jointly by the sub-event receiver 402 and the network interface 420.

After receipt of a sub-event, the method 500 receives a set of comments from one or more users at operation 504. The user comments may be deterministically associated with a sub-event and/or with another user comment, or they may be initially unassociated to any sub-events or previous user comments.

In one embodiment, the operation of receiving comments includes immediately associating the user comments with sub-events. This association may be performed solely based on a selection made by the user/author of the comment, or automatically based on analysis of the content of the user comment.

In one embodiment, the operation of receiving a set of user comments is performed by the user comment receiver 404. In another embodiment, the operation of receiving user comments is performed jointly by the user comment receiver 404 and the network interface 420.

Following the receipt of a set of user comments, the method 500 filters user comments at operation 506. Filtering comments may include sorting the received user comments based on the identities of their respective users (authors). In this embodiment, login credentials of a user that entered a comment is compared against a list of curated/trusted users. In one embodiment, the operation of filtering a set of user comments is performed by user comment filter 406.

After filtering the user comments, the method 500 clusters the filtered comments at operation 508. Clustering may include combining several filtered comments that effectively state the same idea. Accordingly, similar comments may be clustered or combined into just one unified clustered comment that is attributed to each of the users/authors. The unified clustered comment may use the text from one of the original user comments or alternatively use an entirely different set of words that capture the same sentiment as the original set of user comments. In one embodiment, the operation of clustering filtered comments is performed by the comment clustering unit 410.

Following clustering, the unified clustered comments and the received sub-events are formatted at operation 510 to form formatted data. Formatting may include arranging or transforming comment and sub-event data such that the generated formatted data can be transmitted and displayed on the computing devices 418. In one embodiment, this formatting may include arranging the sub-events on the display window 100 with appropriate clustered comments (e.g. within the same conversation frame), based on the context of the sub-events and the clustered comments or an indication made by the users/authors of the comments. In one embodiment, the operation of formatting is performed by the formatting unit 412.

After formatting the unified clustered comments and the received sub-events to produce formatted data, the formatted data is transferred to a remote computing device at operation 512. Transferring the formatted data may include making the formatted data available to computing devices through either a pull, push, or other similar data retrieval scheme. In one embodiment, the operation of transferring the formatted data to remote computers is performed by the network interface 420.

The invention has been described largely by reference to specific examples and in terms of particular allocations of functionality to certain hardware and/or software components. However, those of skill in the art will recognize that a news website commenting system can also be produced by software and hardware that distribute the functions of embodiments of this invention differently than herein described. Such variations and implementations are understood to be apprehended according to the following claims.

An embodiment of the invention may be a machine readable medium (e.g. computer memory or storage devices constituted of optical disc memory, solid state integrated circuit memory, and/or magnetic disk drive memory) having stored thereon instructions which program a processor to perform some of the operations described above, e.g. clustering of similar comments and updating a web page as part of the web interface 100. The term “processor” is used here generically to refer to one or more programmable data processing units, such as one or more central processing units of a server or network of servers. In other embodiments, some of these operations might be performed by specific hardware components that contain hardwired logic. Those operations might alternatively be performed by any combination of programmed computer components and custom hardware components.

While certain embodiments have been described and shown in the accompanying drawings, it is to be understood that such embodiments are merely illustrative of and not restrictive on the broad invention, and that this invention should not be limited to the specific constructions and arrangements shown and described, since various other modifications may occur to those ordinarily skilled in the art.

1. A computerized method for enabling users to post comments on a main event, comprising:
receiving, by a computer system, a plurality of sub-events that describe activities taking place within the main event and displaying the received sub-events in a web page;
receiving a user comment from a remote device in which the web page, including one of the sub-events, is being displayed; and
formatting the user comment and said one of the sub-events to be shown within the same frame in the web page.

2. The method of claim 1, further comprising:
clustering a plurality of user comments based on a similarity between the plurality of comments so that a single comment window is added to the frame that represents all of the clustered plurality of user comments.

3. The method of claim 1, further comprising:
determining whether an author of the user comment is on a list of trusted users and displaying the comment in the frame only if the author is on the list.

4. The method of claim 3, wherein the author is added to the list of trusted users based on a popularity of previous user comments entered by the author.

5. The method of claim 1, wherein the sub-events are received from an external server that is administered by a sports news service provider being a different entity than an administrator of the computer system.

6. The method of claim 1, wherein the computer system associates the user comment with said one of the sub-events based on an analysis of the content and timing of the user comment relative to content and timing of the plurality of sub-events.

7. The method of claim 1, wherein the computer system adds a react button into a sub-event window in which said one of the sub-events is being displayed, wherein the user comment is received in response to selection of the react button and is immediately associated with said one of the sub-events.

8. The method of claim 1, wherein formatting the user comment and the sub-event includes defining the user comment and the sub-event in separate window boxes in a hierarchical structure of the web page.

9. A news website commenting server for formatting a news website based on user comments, comprising:
a sub-event receiver to receive a plurality of sub-events that describe activities taking place within a main event;
a user comment receiver to receive a user comment from a remote user terminal and associate the user comment to one of the sub-events; and
a formatting unit for formatting the user comment and said one of the sub-events such that they are to be displayed on the same web page in the remote user terminal.

10. The news website commenting server of claim 9, further comprising:
a comment clustering unit to cluster a plurality of user comments based on a similarity between the plurality of comments, wherein the formatting unit is to format a single comment window, for display on the same web page, that represents all of the clustered plurality of user comments.

11. The news website commenting server of claim 9, further comprising:
a filtering unit to determine whether an author of the user comment is on a list of trusted users, wherein the formatting unit is to cause the comment to appear in more than one comment window box in the web page if the author is on the list.

12. The news website commenting server of claim 11, wherein if the author is not on the list of trusted users then the formatting unit causes the comment to appear in just one comment window box in the web page.

13. The news website commenting server of claim 8, wherein the user comment receiver associates the user comment with said one of the sub-events based on the content and timing of the user comment relative to content and timing of the sub-event.

14. The news website commenting server of claim 9, wherein the user comment receiver associates the user comment with said one of the sub-events just based on a selection entered via the web page by an author of the user comment.

15. The news website commenting server of claim 9, wherein the formatting unit presents the user comment and associated sub-event in the same frame in the web page.

16. An article of manufacture comprising a machine readable medium having stored instructions that, when executed by a computer system:
receive a plurality of sub-events that describe activities taking place within a main event and display the sub-events in a web page;
receive a user comment from a remote device in which the web page is being displayed,
associate the user comment with one and not all of the sub-events; and
format the user comment and the associated sub-event to be shown within the same frame in the web page.

17. The article of manufacture of claim 16, wherein the machine readable medium has instructions that causes the computer system to:
cluster a plurality of user comments based on a similarity between the plurality of comments, and add a single comments window to the web page that represents all of the clustered plurality of user comments.

18. The article of manufacture of claim 16, wherein the machine readable medium has instructions that causes the computer system to:
determine whether an author of the user comment is on a list of trusted users and if so display the comment in at least two separate window boxes in the web page.

19. The article of manufacture of claim 18, wherein the author is added to the list of trusted users based on a popularity of previous user comments entered by the author.

20. The article of manufacture of claim 16, wherein the computer system associates the user comment with the one of the sub-events, based on analysis of the content and timing of the user comment relative to content and timing of the sub-event.
